(19) United States
(12) Patent Application Publication
(10) Pub. No.: US 2013/0198089 A1
(43) Pub. Date: Aug. 1, 2013

(54) Method And System For Recycling Electronic Devices In Compliance with Second Hand Dealer Laws

(71) Applicant: ecoATM, Inc., San Diego, CA (US)

(72) Inventor: Mark Vincent Bowles, La Jolla, CA (US)

(73) Assignee: ECOATM, INC., San Diego, CA (US)

(21) Appl. No.: 13/794,816

(22) Filed: Mar. 12, 2013

Related U.S. Application Data
(63) Continuation-in-part of application No. 13/438,924, filed on Apr. 4, 2012.
Application No. 13/438,924 is a continuation-in-part of application No. 12/785,465, filed on May 23, 2010, now Pat. No. 8,200,533.
Application No. 12/785,465 is a continuation-in-part of application No. 12/727,624, filed on Mar. 19, 2010, now Pat. No. 7,881,965.
Application No. 12/727,624 is a continuation-in-part of application No. 12/573,089, filed on Oct. 2, 2009, now Pat. No. 8,195,511.
Application No. 12/573,089 is a continuation-in-part of application No. 13/693,032, filed on Dec. 3, 2012.
(60) Provisional application No. 61/472,611, filed on Apr. 6, 2011.
(60) Provisional application No. 61/102,304, filed on Oct. 2, 2008.
(60) Provisional application No. 61/183,510, filed on Jun. 2, 2009.

(51) Int. Cl. G06Q 30/00

(52) U.S. Cl. CPC G06Q 30/018
USPC 705/308

(57) ABSTRACT

A method and system for reselling electronic devices in compliance with second hand dealer laws is disclosed herein. The system includes a kiosk, a network and a server with a database. The kiosk preferably includes an external camera, a fingerprint reader and an identification (card) reader.

### CROSS REFERENCES TO RELATED APPLICATIONS

The present application is a continuation-in-part application of U.S. patent application Ser. No. 13/693,032, filed on Dec. 3, 2012, which is a continuation-in-part application of U.S. patent application Ser. No. 13/438,924, filed on Apr. 4, 2012, which claims priority to U.S. Provisional Patent Application 61/472,611 filed on Apr. 6, 2011, now abandoned, and which is also a continuation-in-part application of U.S. patent application Ser. No. 12/785,465 filed on May 23, 2010, now U.S. Pat. No. 8,200,533, issued on Jun. 12, 2012, which is a continuation-in-part application of U.S. patent application Ser. No. 12/727,624, filed on Mar. 19, 2010, now U.S. Pat. No. 7,881,965, which issued on Feb. 1, 2011, which is a continuation-in-part application of U.S. patent application Ser. No. 12/573,089, filed on Oct. 2, 2009, now U.S. Pat. No. 819,551, issued on Jun. 5, 2012, which claims priority to U.S. Provisional Patent Application 61/102,304 filed on Oct. 2, 2008, now abandoned, and 61/183,510 filed on Jun. 2, 2009, now abandoned, all of which are herein incorporated by reference in their entireties.

### STATEMENT REGARDING FEDERALLY SPONSORED RESEARCH OR DEVELOPMENT

Not Applicable

### BACKGROUND OF THE INVENTION

1. Field of the Invention

The present invention generally relates to reselling electronic devices in compliance with second hand dealer laws.

2. Description of the Related Art

There has been a large increase in the number of electronic devices used by the typical consumer. These devices include cell phones, PDA's, MP3 players, GPS devices, cameras, beepers, remote controls, cordless phones, calculators, etc. The rapid pace at which new technology and models of electronic devices are introduced creates a situation where many consumers upgrade or replace one or more recyclable device on a frequent basis. Often, the consumer does not dispose of the prior electronic device, but rather just stops using it and begins using the new device. This may happen over several generations of such devices.

In addition to the electronic devices mentioned above, there are many other types of devices that have relatively high frequency replacement rates, including portable mobile electronic devices, such as cell phones, MP3 players, etc, and non-portable electronic devices, such as computers, printers, and the like. In addition to electronic devices, there are content based digital media such as games on CD, DVD, or cartridge, or entertainment mass storage items such as CDs, DVDs, BluRay, etc. There is a need for handling of such items in an ecologically friendly manner, both via recycling or by proper disposal procedures. It has not been convenient for owners of electronic devices to either recycle such devices or to properly dispose of such devices. There is currently little incentive for a device owner to “do the right thing” with a used device. When the owner just stops using a device and simply puts it in storage: the opportunity for recycling or re-use by another party is lost. If the owner just throws the device away in normal trash containers, the proper recycling or safe disposing of the device is thwarted. Efforts have been made to recycle these electronic devices.

One particular problem associated with recycling is complying with second hand dealer laws. Many States began the regulation of secondhand dealers and pawnshops in mid-1900's to help prevent trafficking in stolen goods. The general idea was that by requiring secondhand dealers to capture information about each item they bought and each seller that sold them, this would deter the fencing of stolen items and allow law enforcement to identify reported stolen items and track them back to the seller. Over the years, many of these laws expanded to mandate the filing of the reports with local government, but many local governments chose not to enforce the law because it was not very successful as a means of tracing stolen property and it generated an overwhelming paperwork burden for all sides. Because pawnbrokers conduct their business in such a completely different way than most other secondhand dealers, to a great extent, pawnbrokers are more closely regulated than secondhand dealers. Many secondhand dealer laws (AKA pawn shop license, used good dealer permit, and the like) are aimed to target jewelry, gold, and other precious metals but some also include serialized electronics (which includes mobile phones and other electronics). Unfortunately, a traditional analysis of laws originally written decades ago no longer accurately reflects how business is done in this new millennium so much of the interpretation and enforcement is left to local law enforcement and licensing officials. When these laws exist and are enforced, they generally require transactions to be reported to local law enforcement, and sometimes require a hold period of between 7 and 30 days before items can be resold, and fingerprint and ID capture of each seller.

The prior art has failed to provide an effective mechanism for recycling electronic devices and complying second hand dealer laws.

### BRIEF SUMMARY OF THE INVENTION

The present invention enables one to securely recycle, donate, trade-in, and/or sell electronic devices in a publicly accessible location with compliance with second hand dealer laws.

One aspect of the present invention is a system for reselling electronic devices in compliance with second hand dealer laws. The system includes an apparatus, a network, and a server with a database. The apparatus comprises a fingerprint reader, an identification reader, an exterior imaging component, a processor, an inspection area, an imaging component within the inspection area, and an electrical connector within the inspection area. The electrical connector is capable of connection to an electronic device positioned within the inspection area. The server connected to the apparatus over the network. A processor of the apparatus is configured to validate an identification of a reseller, process a fingerprint of the reseller to the database, photograph an image of the reseller to the database, and acquire an identification of the electronic device. The processor is configured to collect as transfer data the reseller image, the reseller identification, the fingerprint of the reseller, and the identification of the electronic device. The processor is configured to transmit the transfer data to the server over the network. The server is configured to analyze the transfer data in view of a second hand dealer law for a jurisdiction of a location of the apparatus, determine a procedure for compliance of the second hand dealer law, and comply with the second hand dealer law.

Another aspect of the present invention is a method for reselling electronic devices in compliance with second hand dealer laws. The method includes submitting an electronic device for reselling at an apparatus. The method also includes validating an identification of a reseller of the electronic device. The method also includes acquiring a fingerprint of the reseller. The method also includes acquiring an image of the reseller. The method also includes acquiring an identification of an electronic device. The method also includes collecting as transfer data the recycler image, the reseller identification, the fingerprint of the reseller, and the identification of the electronic device. The method also includes transmitting the transfer data to a server over a network. The method also includes analyzing the transfer data in view of a second hand dealer law for a jurisdiction of a location of the apparatus. The method also includes determining a procedure for compliance of the second hand dealer law. The method also includes complying with the second hand dealer law.

To complete a transaction each reseller must provide a valid ID and must be at least 18 years of age. The kiosk uses state of the art ID scanner and validation software that not only photographs the ID but validates for authenticity by examining the ID for holograms, watermarks, or other specific authentication methods used in all 50 States. Resellers cannot proceed or be paid unless a valid ID is presented to the kiosk. Images of these IDs are collected, stored, and are available as part of the reporting process if required. The kiosk in combination with the server utilizes software for verifying ID's through facial recognition algorithms, the photo on the ID to the photos of the person seen through the cameras at the kiosk. Many law-enforcement agencies rely on similar biometric software for validating ID's to specific people.

The system is a real-time communication technology that enables personnel to approve or reject each transaction at each kiosk from a remote call center by viewing an image of the seller and their ID so that the face and information is verified by a human and not just software. This process takes only a few seconds per transaction through the live attendant software. When operated by a trained operator it is estimated that a single operator can handle the live transaction volume of between 150 and 300 kiosks at a time.

To complete a transaction each consumer must provide a valid thumbprint. The kiosk uses the newest technology in thumbprint reading technology to ensure a valid thumbprint is captured on every transaction. This technology is widely used by government agencies around the world to collect and verify thumbprints. The software actually validates the captured thumbprint to make sure it is legible and acceptable by industry standards. Consumers cannot proceed or be paid until a valid thumbprint is captured. Images of these Thumbprints are collected, stored, and are available as part of the reporting process if required.

The kiosk electronically extracts a serial number (IMEI, MEID, etc.) from each device (if technically possible) and provides this as part of the reporting process if required.

The kiosk collects and stores multiple high resolution images of each seller of each device at the kiosk and can provide these as part of the reporting process.

Although not required by law, the server collects and stores multiple high resolution images of each device collected and can provide these as part of the reporting process.

An additional aspect of the present invention is a kiosk for recycling electronic devices such as mobile phones, tablet computes. e-readers, MP3 players, and the like in compliance with second hand dealer laws. The kiosk preferably has a housing with a touch screen display for user interaction. The kiosk also has an inspection area defined by an upper chamber, a lower chamber and a transparent plate for transporting an electronic device into the inspection area. The upper and lower chambers preferably have mirrors on interior surfaces along with imaging components such as cameras in order to obtain multi-angled views, or even a 3-D profile, of an electronic device within the inspection area. The kiosk also preferably has a carousel with multiple different electrical connectors in order to electrically connect to an electronic device. The kiosk also preferably has a mechanism for automatically binning the electronic device. The kiosk also has a processor configured to perform visual analysis for identification of the electrical device and to determine a condition of the electronic device, especially a LCD display of the electronic device. The processor is configured to perform an electrical analysis of the electronic device. Further, the processor is configured to erase or transfer data from electronic device.

The kiosk of the method comprises a housing, the housing comprising a user interface on an exterior surface of the housing for the user to input information, an upper dome and a lower dome, wherein the upper dome and the lower dome comprise a plurality of mirrors. The kiosk further comprises an upper chamber camera, a lower chamber camera and a transparent surface. The kiosk further comprises a processor within the housing and in communication with the at least one camera, the processor configured to identify the brand and model number of the mobile communication device based on at least one of the information from the user and the images from the at least one camera, the processor configured to determine a purchase price for the used model of the mobile communication device.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is a block diagram of a system for reselling electronic devices in compliance with second dealer laws.

FIG. 2 is an isolated view of a mobile phone connected to an electrical connector for an erasure of data from the mobile phone.

FIG. 3 is an isolated view of data stored on the mobile phone of FIG. 2.

FIG. 4 is an isolated view of a transfer of data from a recycled electronic device to a new electronic device within an inspection area of a recycling kiosk.

FIG. 5 is a view of a transfer of data from a recycled electronic device to a new electronic device within an inspection area of a recycling kiosk.

FIG. 6 is an isolated view of an imaging component within an inspection area of a recycling kiosk allowing for viewing of a mobile phone for analysis by a remote operator.

FIG. 7 is a perspective view of an operator viewing a display screen showing the image of a mobile phone within an inspection area of a recycling kiosk.

FIG. 8 is a perspective view of a recycling kiosk.

FIG. 8A is a front view of the recycling kiosk of FIG. 8.

FIG. 8B is an isolated view of a front of the recycling kiosk of FIG. 8.

FIG. 8C is an isolated view of a front of the recycling kiosk of FIG. 8.

FIG. 9 is an isolated view of an electrical connector wheel.

FIG. 9A is an isolated view of an electrical connector is a staging area.

FIG. 9B is an isolated view of an electrical connector in a detached position.

FIG. 9C is an isolated view of an electrical connector being detached.

FIG. 9D is an isolated view of an electrical connector being retracted.

FIG. 10 is a perspective view of internal components of a kiosk.

FIG. 10A is a perspective view of internal components of a kiosk.

FIG. 10B is a perspective view of internal components of a kiosk.

FIG. 10C is a perspective view of internal components of a kiosk.

FIG. 11 is an isolated view of a phone an inspection plate of a kiosk.

FIG. 11 is an isolated view of a phone being transferred in the kiosk.

FIG. 11B is an isolated view of a phone being transferred in the kiosk.

FIG. 11C is an isolated view of a phone being binned in the kiosk.

FIG. 12 is a block diagram of components of a recycling kiosk.

FIG. 13 is a block diagram of components of a recycling kiosk.

FIG. 14 is an isolated view of an inspection area of a kiosk.

FIG. 15 is an isolated view of a camera in a dome of a kiosk.

FIG. 16 is an isolated view of a phone in an inspection area of a kiosk.

FIG. 17 is a front view of a phone.

FIG. 18 is a front view of a phone connected to an electrical connector.

FIG. 19 is a flow chart for recycling an electronic device.

FIG. 20 is a flow chart for a pre-acquisition auction method.

FIG. 21 is a block diagram of a system for reselling electronic devices in compliance with second dealer laws.

FIG. 22 is a method for reselling electronic devices in compliance with second hand dealer laws.

### DETAILED DESCRIPTION OF THE INVENTION

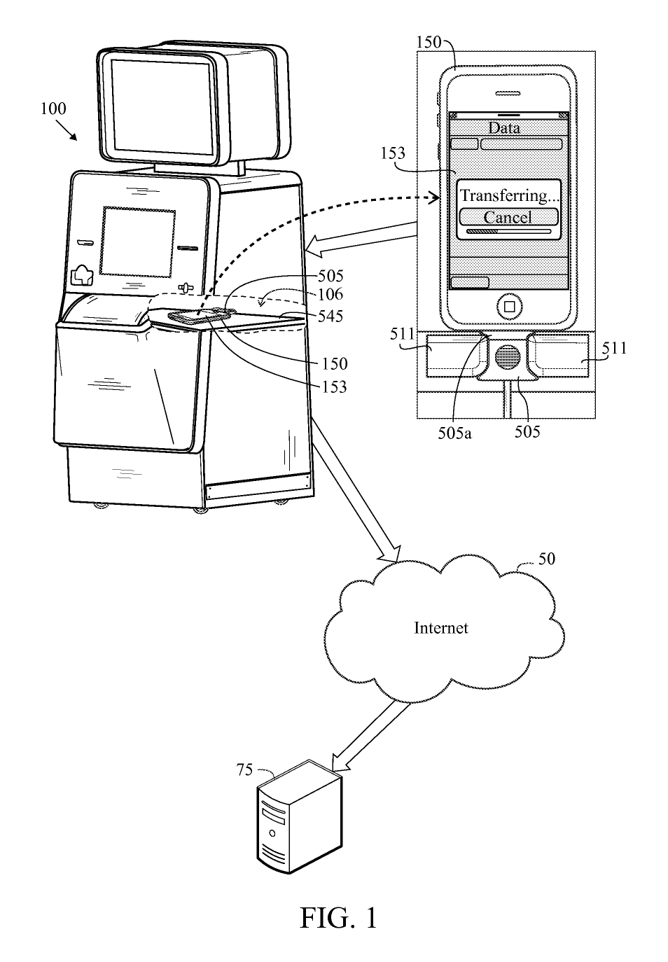

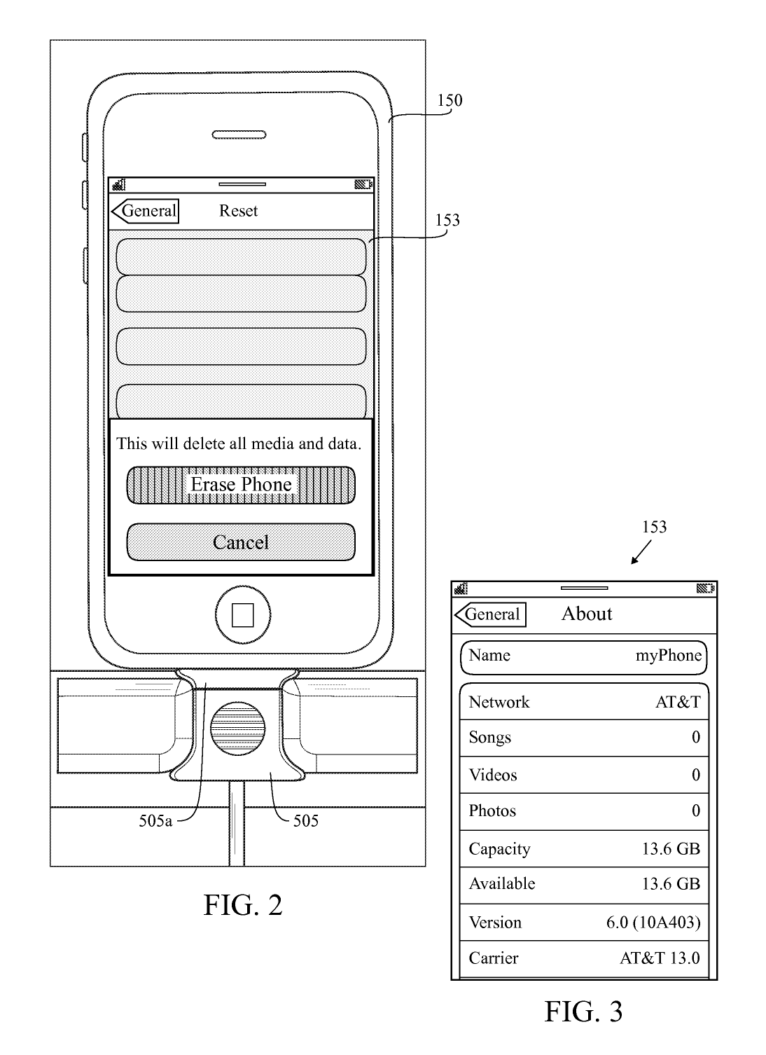

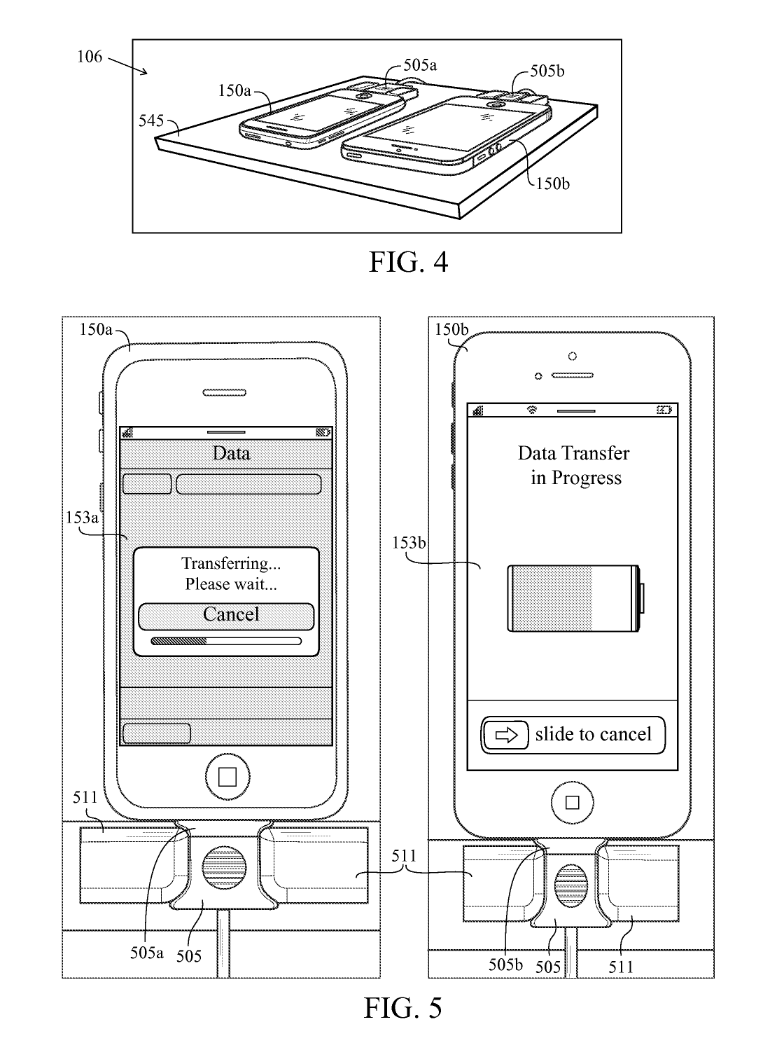

FIG. 1 is a block diagram of a system for reselling electronic devices in compliance with second dealer laws. A kiosk for recycling electronic devices and providing financial remuneration is generally designated 100. The electronic device 150 may be a Smart Phone, mobile phone, tablet computer, IPOD® device, MP3 Player, GPS device, e-reader, etc. Within an inspection area, the electronic device 150 is placed on a transparent plate 545 and connected to an electrical connector 505. Data from the electronic device 150 is either erased or transferred from the electronic device 150. If erased, as shown in FIG. 2, a processor of the kiosk 100 is configured to instruct the electronic device 150 to erase all personal data, such as shown in FIG. 3. Other data, such as operating software for the electronic device, is not erased. If the data is to be transferred, one embodiment includes a processor of the kiosk 100 configured to transfer the data from the electronic device 150, through the kiosk 100 over a network 50 to a server 75 for storage in a database for eventual retrieval by an end-user of the electronic device. In another embodiment, as shown in FIGS. 4 and 5, data is transferred from a recycled electronic device 150a to a new electronic device 150b. Both devices 150a and 150b are preferably placed on a transparent plate 545 within the inspection area 106 and connected to electrical connectors 505a and 505b respectively. The transfer is shown on the display screens 153a and 153b of the electronic devices 150a and 150b.

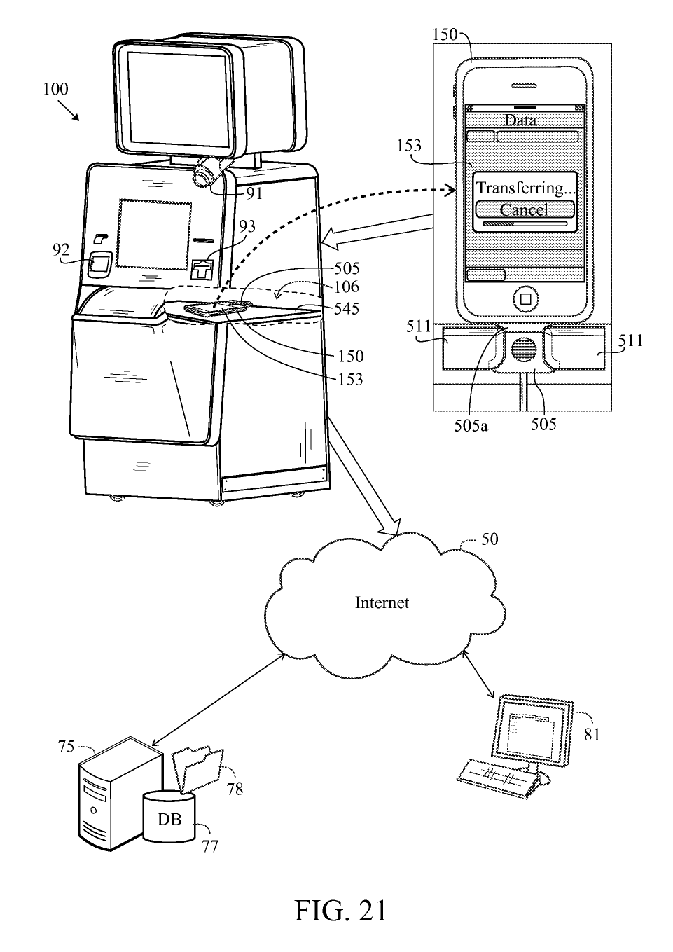

In a preferred embodiment, FIG. 21 is a block diagram of a system for reselling electronic devices in compliance with second dealer laws. A kiosk for reselling electronic devices and providing financial remuneration is generally designated 100. The electronic device 150 may be a Smart Phone, mobile phone, tablet computer, IPOD® device, MP3 Player, GPS device, e-reader, etc. The kiosk 100 preferably includes an external camera 91, a fingerprint reader 92 and an identification (card) reader 93. Within an inspection area 106, the electronic device 150 is placed on a transparent plate 545 and connected to an electrical connector 505. A processor of the apparatus is configured to validate an identification of a reseller, process a fingerprint of the reseller to the database, photograph an image of the reseller to the database, and acquire an identification of the electronic device. The processor is configured to collect as transfer data the reseller image, the reseller identification, the fingerprint of the reseller, and the identification of the electronic device. The processor is configured to transmit the transfer data to the server over the network.

Data from the electronic device 150 is removed from the electronic device 150 and transferred from the electronic device 150, through the kiosk 100 over a network 50 to a server 75 for storage in a database 77 as an electronic transfer data file for retrieval if necessary by governmental regulatory agencies. The is configured to analyze the transfer data in view of a second hand dealer law for a jurisdiction of a location of the apparatus, determine a procedure for compliance of the second hand dealer law, and comply with the second hand dealer law.

The server 75 is also configured to transmit a communication to a client device 81 at a governmental regulatory agency over the network 50 if necessary. In one further embodiment, the identification of the electronic device is compared against a stolen electronic database as a filter prior to purchasing the electronic device from the reseller, using an IMEI, MEID, or serial number of the electronic device. In yet an additional further embodiment, the kiosk 100 is located in the retail store with the client device 81. In yet an additional further embodiment, the client device 77 is at a home or office of an end user and the new electronic device 150a is uploaded with the transfer data 78 by the end user.

In one embodiment, the serve 75 transmits a communication to the end user in the form of an email with the data attached in an electronic file, or a link to the data at the database.

In another embodiment, the server 75 uses facial recognition software to identify a reseller based on an image acquired from the external camera 91 of the kiosk 100 and an image of the reseller's identification from the identification reader 93. The server 75 compares the two images, and may also compare the images to facial image databases.

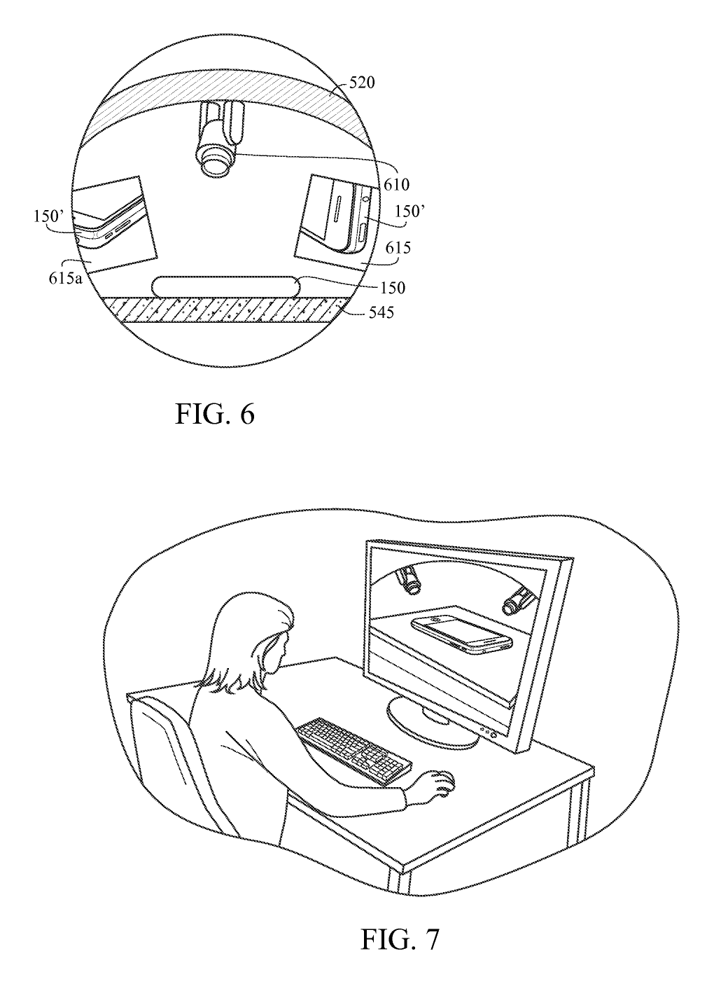

In yet another embodiment of the invention, as shown in FIGS. 6 and 7, an operator in a remote location visually inspects an electronic device 150 within an inspection area 106 of a kiosk 100 using at least one camera 610. The operator also receives data from an electrical analysis of the electronic device 150 as explained below. In this manner, the remote operator provides human interaction for a reseller attempting to resell the electronic device 150.

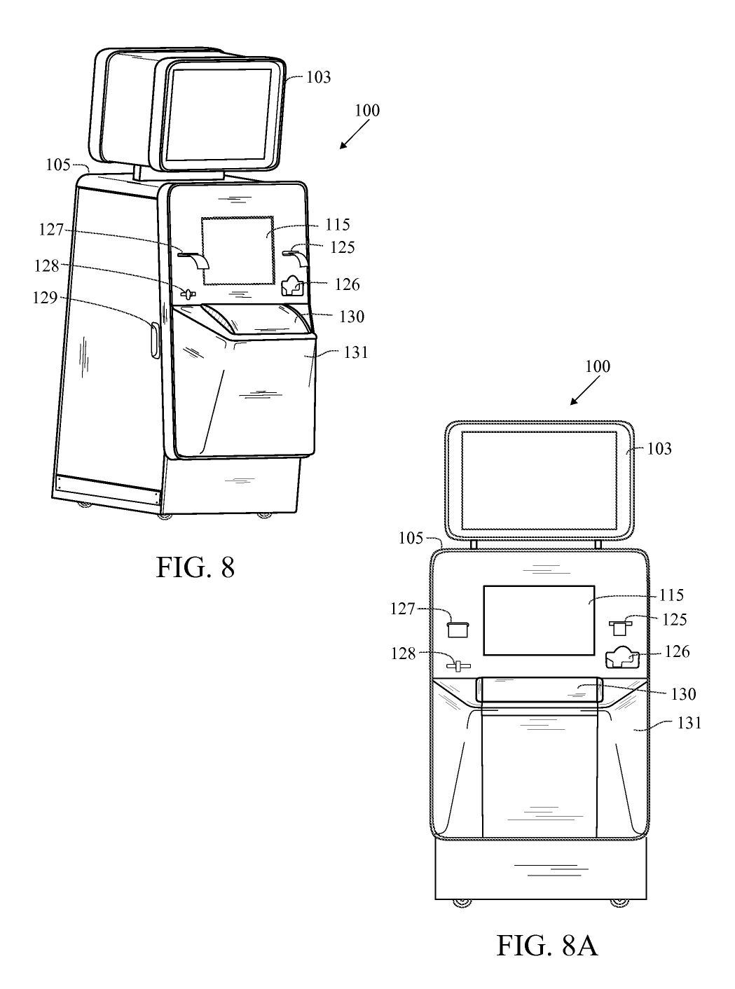

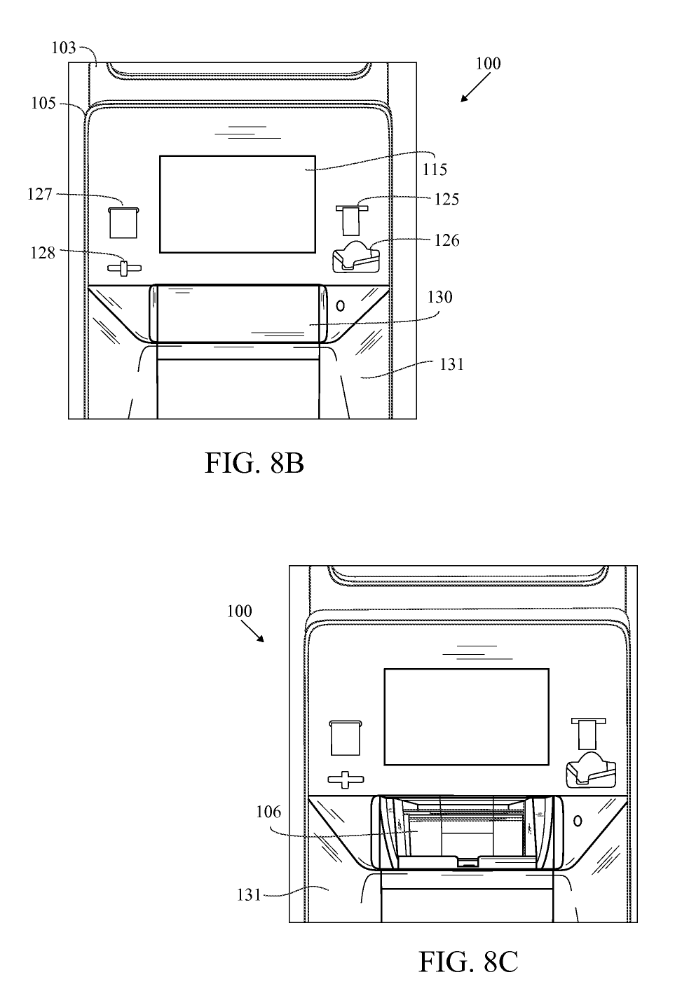

As shown in FIGS. 8, 8A, 8B and 8C, the kiosk 100 has a housing 105 in a pseudo-rectangular cube shape. A header 103 allows for marketing and videos. An access door 130 in a front body area 131 provides access to an inspection area 106 for electronic devices. The front of the housing 105 has a display screen 115 for providing information to a user, and acts as a user interface in a touch screen embodiment. The exterior of the housing 105 also preferably has a label printer 125, a voucher dispenser 126, a receipt printer 127, and a cash or card dispenser 128. The exterior housing may also have a thumbprint reader.

The kiosk 100 allows for automatic visual analysis of an electronic device to identify the electronic device and to determine electronic device is damaged in order to ascertain a value for recycling the electronic device. Further, the kiosk 100 also allows for electrical analysis of the electronic device.

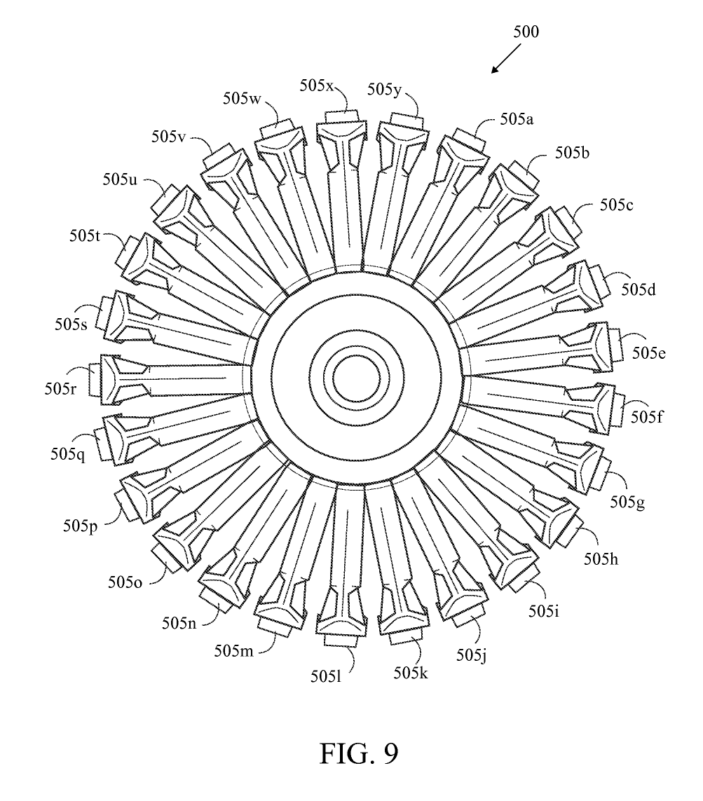

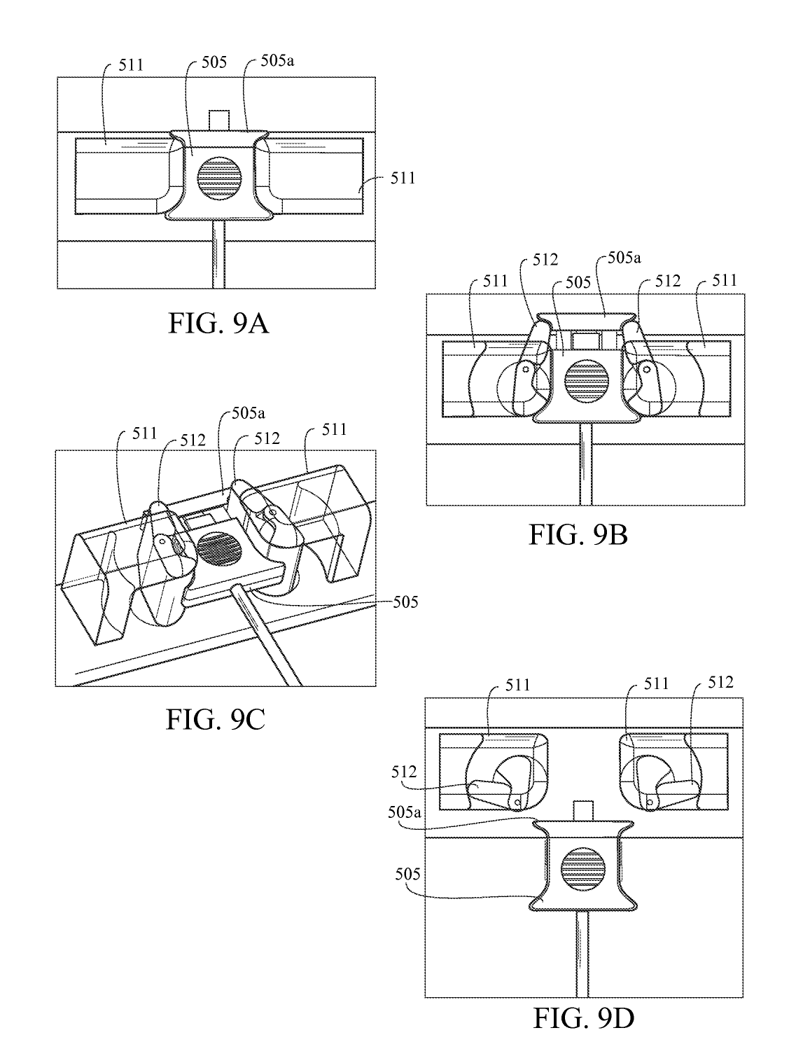

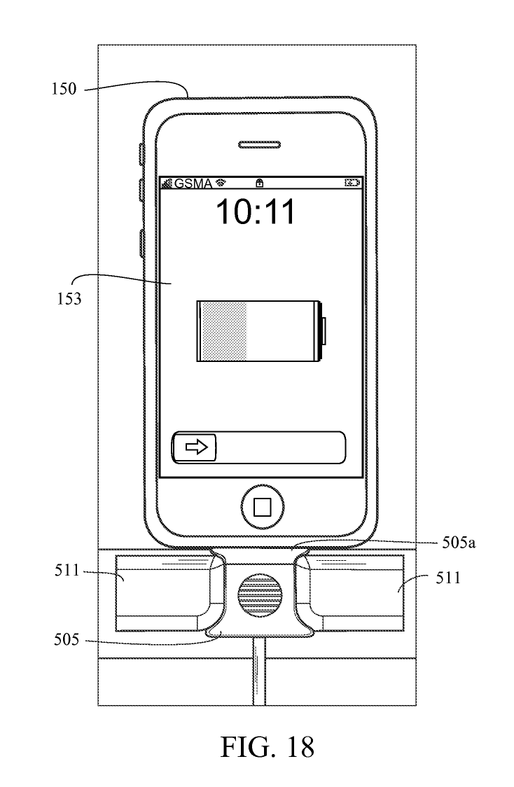

As shown in FIGS. 9, 9A, 9B, 9C and 9D, the kiosk 100 comprises a carousel 500 containing a plurality of electrical connectors 505a-505y. Each of the electrical connectors 505 has a unique connection plug for removable connection to an electronic device. Each of the electrical connectors 505a-505y has a cartridge removeably secured in the carousel 500. Thus, new electrical connectors 505 can be substituted for older electrical connectors 505. Further, the kiosk 100 is designed to allow for automatic removal of the electrical connector 505 using detachment mechanism 511. In FIG. 9A, the electrical connector 505 is in a staging area, where it would be connected to a port of an electrical device (as shown FIG. 18). Next, as shown in FIGS. 9B and 9C, hinged arms 512 of the detachment mechanism 511 engage a moveable member of the electrical connector 505 to force the outward movement of the moveable member and the disconnection of the electrical connector 505 from a port of an electronic device (as shown in FIG. 18). As shown in FIG. 9D, the electrical connector 505 is retracted by a cable from the detachment mechanism 511.

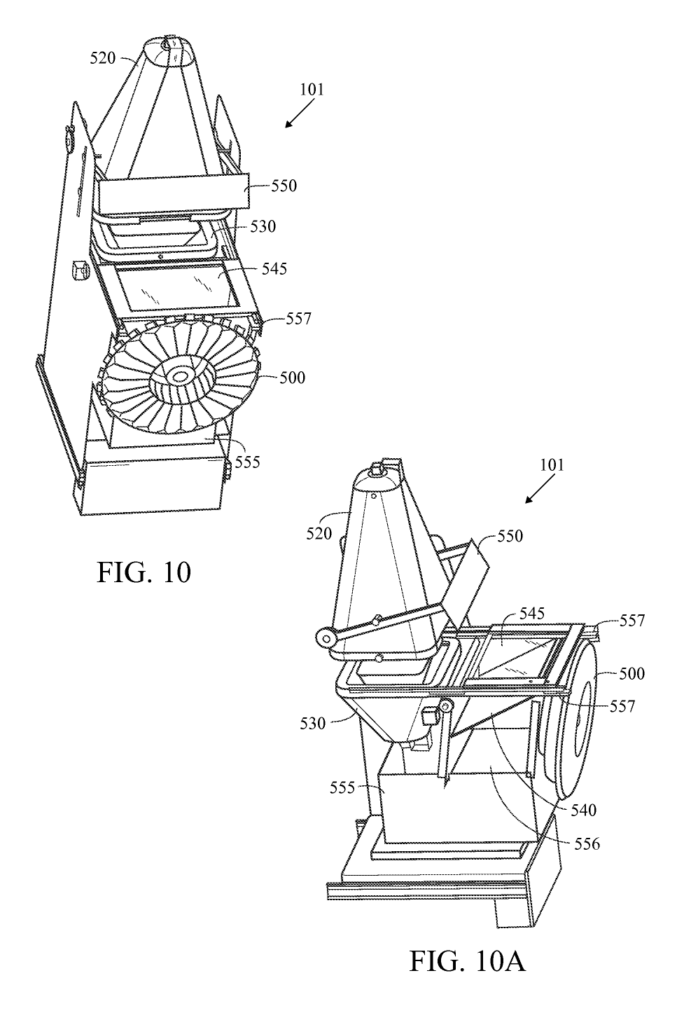

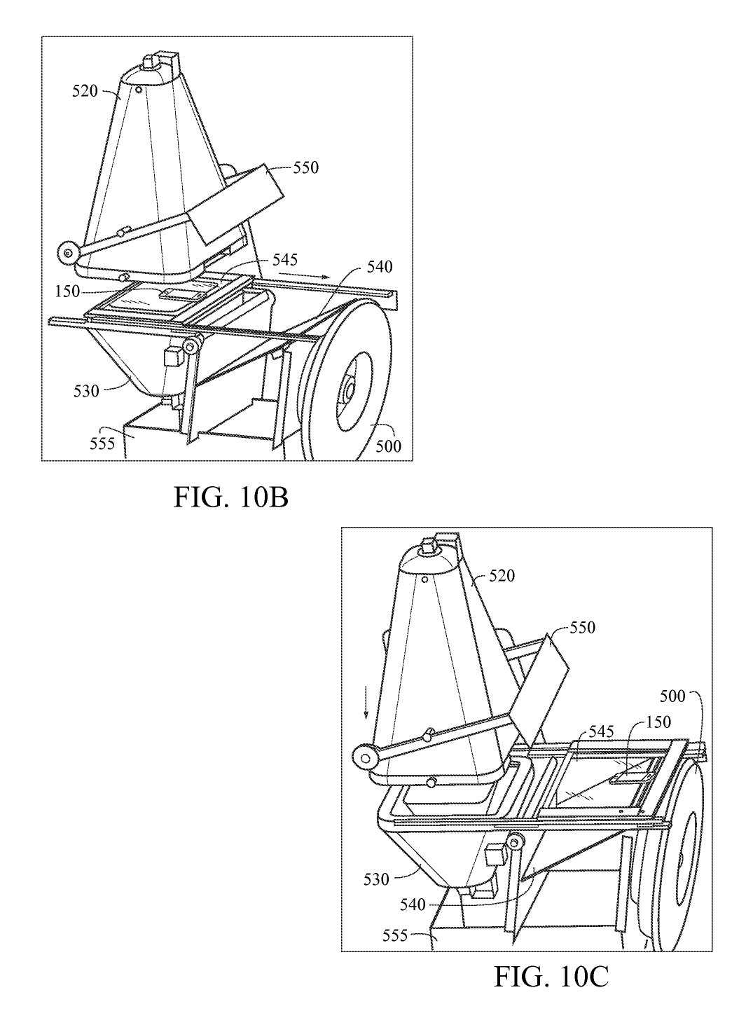

As shown in FIGS. 10, 10A, 10B and 10C, the internal mechanism 101 of the kiosk 100 includes an upper chamber 520, a lower chamber 530, a binning plate 540, a transparent plate 545, a door 550, a bin 555 and the carousel 500. Preferably, the carousel 500 is able to hold approximately 25 electrical connectors 505, wherein the electrical connectors 505 are interchangeable to easily adapt to the variations in USB and other like connections. As shown in FIG. 10B, a mobile phone 150 is placed on the transparent plate 545 and transferred to an inspection area 106 within upper chamber 520 and lower chamber 530. Both the upper chamber and the lower chamber preferably have a bell-like shape. As shown in FIG. 10C, the mobile phone is moved between the upper chamber 520 and the lower chamber 530 for visual analysis. The transparent plate, preferably composed of glass of a transparent plastic material, allows for imaging components within the upper chamber 520 and lower chamber 530 to obtain multiple view images of the mobile phone 150. Preferably, a 3-D profile of the mobile phone is generated in order to provide visual analysis for identification and condition of the mobile phone. Once the visual analysis is complete, the transparent plate 545 moves out from between the upper chamber 520 and lower chamber 530.

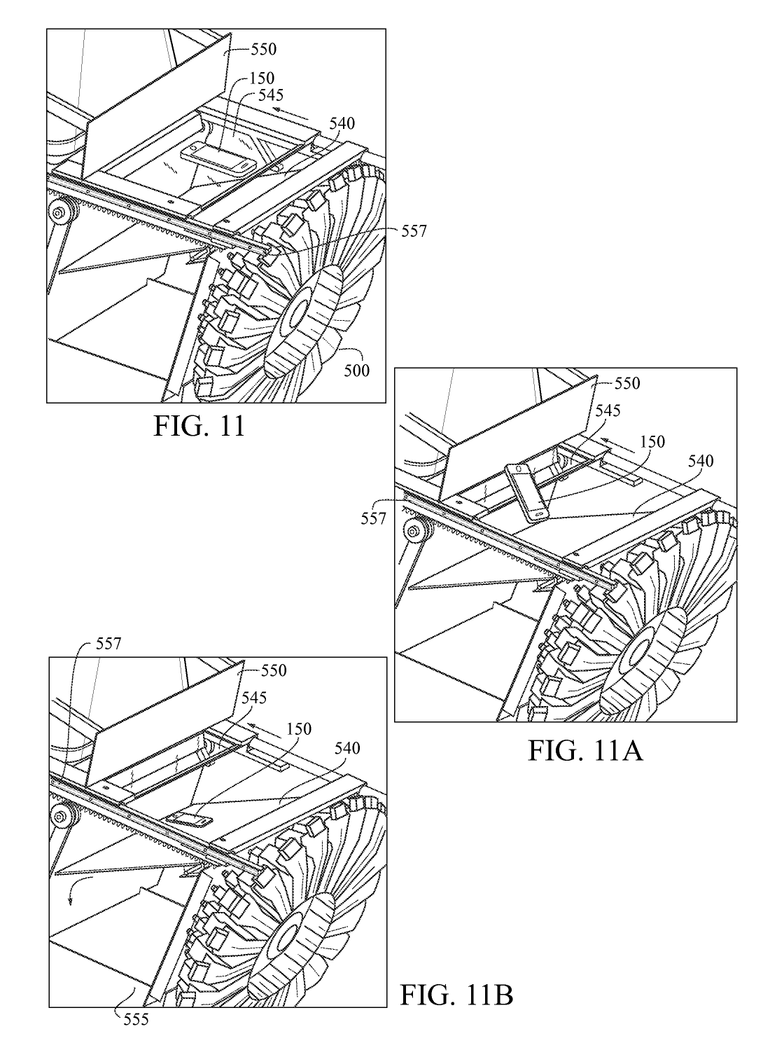

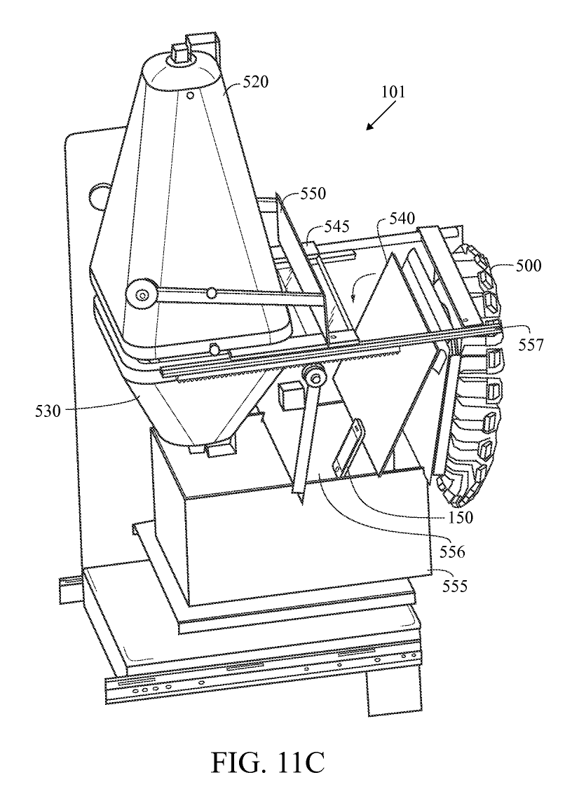

FIGS. 11, 11A, 11B, and 11C, show the automatic transport and binning of an electronic device 150 within the internal mechanism 101 of the kiosk 100. As shown in FIG. 11, the door 550 is lowered to reside above the transparent plate 545, which is then moved inward with the mobile phone 150 thereon. As shown in FIG. 11A, as the transparent plate 545 is moved inward, the mobile phone is blocked by the door 550 and engages binning plate 540 as the mobile phone begins to fall into an opening created by the inward movement of the transparent plate 545. As shown in FIG. 11B, once the mobile phone is on the binning plate 540, the binning plate 540 is slowly lowered on one side to open into the bin 555. As shown in FIG. 11C, the mobile phone 150 slowly falls through an opening 556 into the bin 555 to secure the mobile phone 150 and for collection at a later time. The entire process performed at a rate of speed to prevent damage to the electronic device being recycled.

The kiosk 100 is of a typical size and shape of a vending machine, such as a soda machine, coin changing machine, can recycling machine, or other vending machines. The housing 105 of the kiosk 100 protects the internal mechanism 101 and secures electronic devices submitted for recycling. The housing 105 is preferably constructed of a metal material, such as steel or aluminum, to prevent authorized access to the kiosk 100.

The inspection area 106 is preferably designed to permit a detailed visual inspection of an electronic device such as a mobile phone, tablet computer, e-reader, MP3 players, PDA. The walls of the inspection area are preferably white and/or mirrored to provide imaging of the electronic device.

The couplings from the kiosk 100 and to a remote computer are preferably a single coupling to a communications network such as the internet via wired LAN, wireless LAN, cellular or any other proprietary communications system. The Kiosk 100 preferably includes a processor 160 for processing the information obtained from the mobile phone and for controlling the components of the kiosk 100. Preferably, the processor 160 is a standard personal computer (“PC”) or other type of embedded computer running any operating system such as Linux or MAC OS. The processor 160 is most preferably a small form factor PC with integrated hard disk drive (“HDD”), central processing unit (“CPU”) and universal serial bus (“USB”) ports to communicate with the other components of the kiosk 100. One most preferred CPU is a DELL PC OPTIPLEX 780. Alternatively, the processing means is a microprocessor with a standalone motherboard which interfaces to a discrete HDD, power supply and the other components of the kiosk 100. The kiosk 100 preferably includes a memory 161 or other storage device, such as a disk drive, that stores the executable applications, test software, databases and other software required to operate the recycling kiosk 100.

The external communication component for the kiosk 100 preferably includes a wired Ethernet to provide connection to the internet, or alternatively the external communication component includes a wireless modem such as GSM, CDMA, 3G and 4G technologies for data communications.

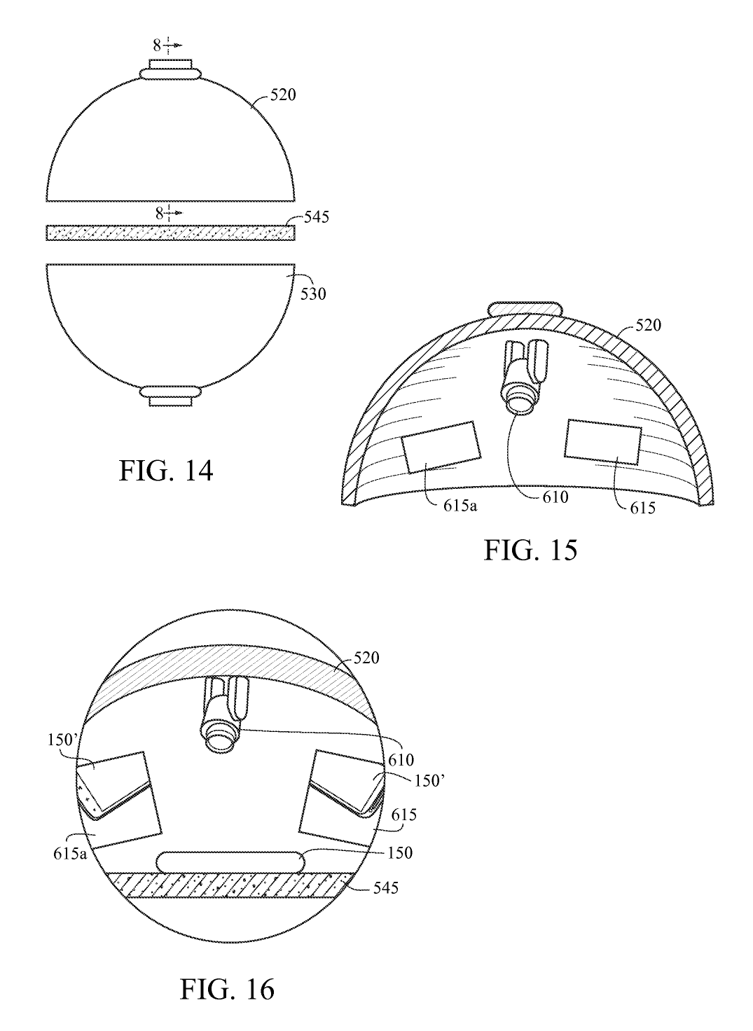

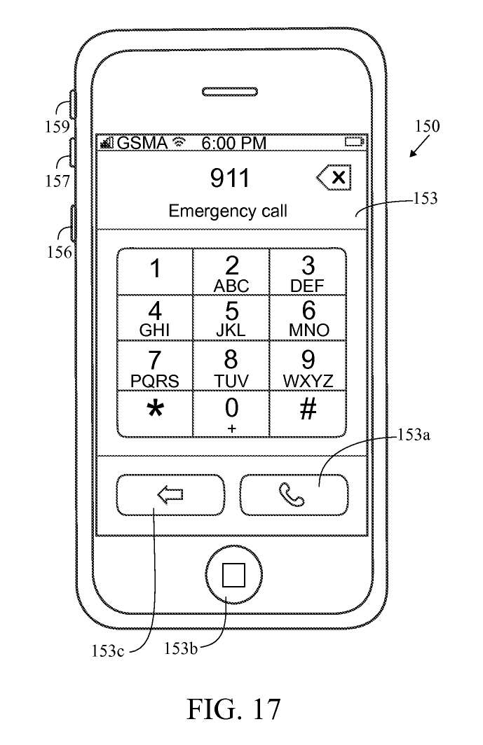

As shown in FIGS. 14-16, the visual inspection of an electronic device such as a mobile phone 150 in the inspection area 106 is preferably performed by at least one camera 610 within the upper chamber 520. The lower chamber 530 also preferably has at least one camera or other imaging component such as a scanner. Alternatively, the visual inspection is performed by multiple cameras. A preferred camera 610 is a 1 megapixel machine vision camera. If a single camera 610 is utilized in the inspection area 106, the camera 610 preferably is movable to increase a field of view of the inspection area 106 to inspect the electronic device 150 such as a mobile phone placed on the transparent plate 545. The camera 161 is preferably movable. Preferably the camera 610 is positioned to image a LCD screen 153 of the electronic device 150 to determine if the LCD screen 153 is damaged. The interior surfaces of the upper chamber 520 and lower chamber 530 preferably include mirrors 615 in order to optimize viewing of an electronic device positioned within the inspection area 106. As shown in FIG. 16, a reflection 150′ of a mobile phone 150 is illustrated. The camera 610 is also preferably movable to image a data port of the electronic device to determine the type of electrical connector 505 for the electronic device in order to perform an electrical analysis of the electronic device. Alternatively, the entire interior surfaces of the upper chamber 520 and the lower chamber 530 are mirrored for optimization of imaging of the electronic device. The camera(s) alternatively are CCD or CMOSS.

Also, time is of the essence when inspecting the electronic device. The analysis is completed within an illumination period of the electronic device, wherein the illumination device comprises the time from when the display screen of the electronic device is illuminated to the time the display screen converts to an energy conserving mode, evidences by the screen blacking out. During the inspection, the brightness of the illumination is also measured. The lighting preferably comprises LED based lighting with beam splitters, or alternatively UV lighting.

The transparent plate optionally operates as a weight scale to obtain a mass of the electronic device for use in determining a remuneration value. For example, if the mass of the electronic device 150 is less than set forth in a vendor specification for the electronic device, then one or more components of the electronic device may be missing, such as the battery for the electronic device 150.

Preferably, visual inspection and recognition software is utilized by the kiosk 100 to analyze an electronic device. In one preferred method, a recognition algorithm is applied to a specific make and model of a electronic device. The visual inspection and recognition software determines the borders of a electronic device 150 under inspection to determine the external dimensions of the electronic device 150. The external dimensions are utilized to determine a subset of possible mobile phones from a master database of mobile phones stored in the memory 161 of the kiosk 100 or available online to the kiosk 100 using external communications. The visual inspection and recognition software then preferably uses a set of secondary and tertiary features to further distinguish the electronic device 150. These secondary and tertiary features can include placement and size of the display screen, placements and size of the keyboard, unique buttons, placement of ports, and other distinguishing features. Once an exact make and model of the electronic device is determined, the visual inspection and recognition software subtracts an image of the electronic device 150 from an image of a perfect electronic device for the same make and model. The result of the subtraction is preferably a quantifiable number of pixels that are calibrated into categories of broken or missing parts, cracked screen, and low, medium or high wear.

Alternatively, the visual inspection is performed using neural network pattern recognition techniques to identify the mobile phone 150, then filter algorithms are utilized to determine defects such as cracked screens. Further, those skilled in the pertinent art will recognize that other visual inspection techniques may be employed without departing from the scope and spirit of the present invention.

The electrical analysis of an electronic device 150 is preferably performed using an electrical connector 505 connected to a data port of a electronic device 150 as discussed above in reference to FIGS. 2, 2A, 2B, 2C and 2D. Once the make and model of the electronic device 150 is determined, either by visual inspection or user input using a user interface such as touch screen display 115, the correct electrical connector 505 is dispensed by the carousel 500 for connection to the data port of the electronic device 150. The connection of the electrical connector 505 to the electronic device 150 is preferably performed automatically by the kiosk 100. Alternatively, the proper choice of electrical connector 505 is rotated into position on the carousel 500 and illuminated or in some other way presented to the consumer for manual connection of the electrical connector 505 to the data port of the electronic device 150. Electrical analysis software is preferably utilized by the kiosk 100 to interact with the electronic device 150. The electrical analysis preferably determines if the mobile phone is capable of activation, maintaining a charge, performing correctly, powering a display screen of the electronic device 150, providing make, model, serial number and other pertinent information about the electronic device 150, and other relevant information.

The touch screen display 115 preferably includes a keypad, user selection buttons, soft keys, and other similar components. The touch screen display 118 is used to enable quick and easy access to various features and functions of the recycling kiosk 100. The recycling kiosk 100 preferably dispenses various forms of payment, including cash, credit cards, debit cards, chip cards, gift cards from the kiosk's host location or other gift cards, and other magnetic striped cards or electronic payment methods. The kiosk 100 also uses the barcode reader to read the barcode identification on the inside of the battery pack. A UV detector is used for reading “invisible” barcodes in use by certain vendors such as Apple and others. The bar code reader, camera, and/or UV detector of the kiosk 100 is another technique used to identify the product model, IMEI #, and/or FCC ID. Alternatively, the kiosk 100 communicates with the electronic device 150 using wireless communications to test and if necessary erase data from the electronic device 150.

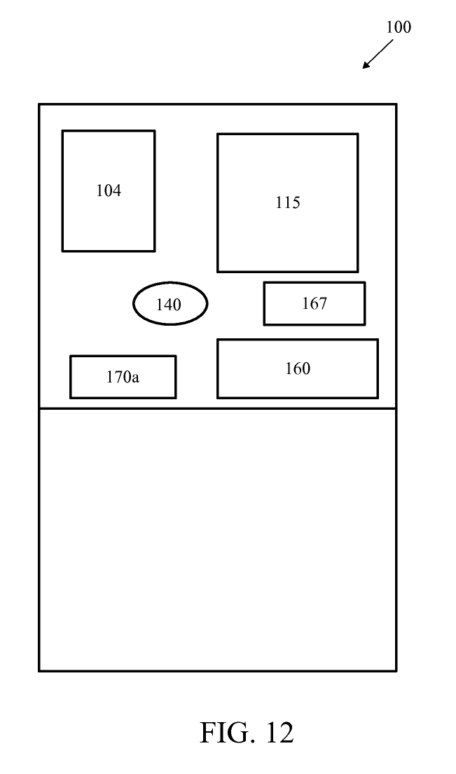

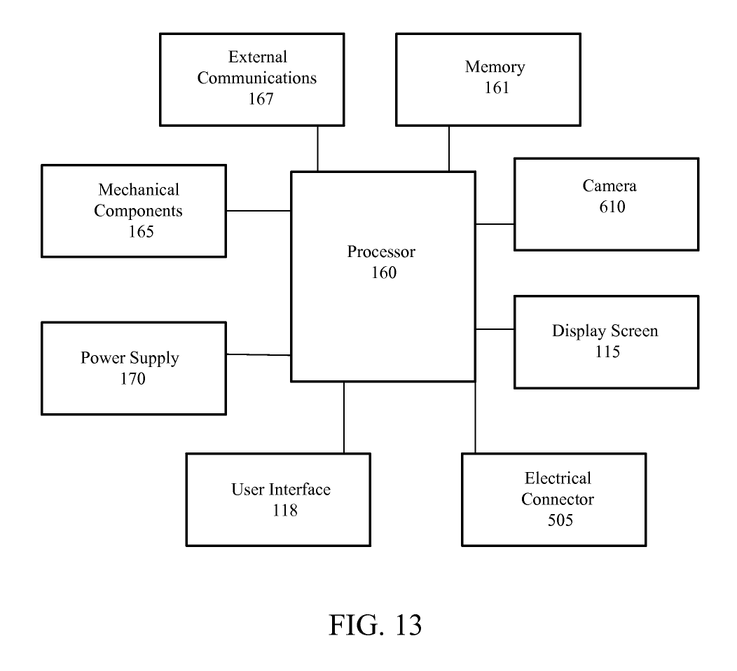

FIG. 13 is a block diagram of the main components of the kiosk 100. A processor 160 is preferably in communication with the other components of the kiosk 100. The memory 161 preferably contains a database of information on multiple mobile phones including images, physical characteristics, prices and other similar information. The external communications 167 preferably communicates through a wireless connection or Ethernet with a network to receive and transmit information to a remote site. The power supply 170 is preferably received through a plug-in connection to a wall outlet. The mechanical components 165 include the electrical connector carousel 500, the transparent plate 545, the binning plate 540, the door 550, and other similar components. The camera 610 or cameras, electrical connectors, and a user interface interact with the processor 160 as discussed above. FIG. 12 illustrates an internal back of a recycling kiosk 100. As shown a processor 160 is preferably a personal computer having a battery backup 170a, a wireless connection 167 for external communications, an electrical connection 140, a receipt dispenser 104 and a display screen 115.

The processor 160 identifies the electronic device 150 submitted for recycling using information from the visual inspection and user interface. The processor 160 also determines the proper electrical connector 505 for connection to the data port of the electronic device 150 using information obtained during the visual inspection or from the user interface. The processor 160 also directs and receives information from the electrical analysis of the electronic device 150 performed using the electrical connector 505 connected to the data port of the electronic device 150. The processor also preferably determines a financial remuneration for the submitted electronic device 150 based on the visual inspection, optionally the electrical analysis and data stored in the memory 161 of the kiosk or information provided externally through the external communication component 167.

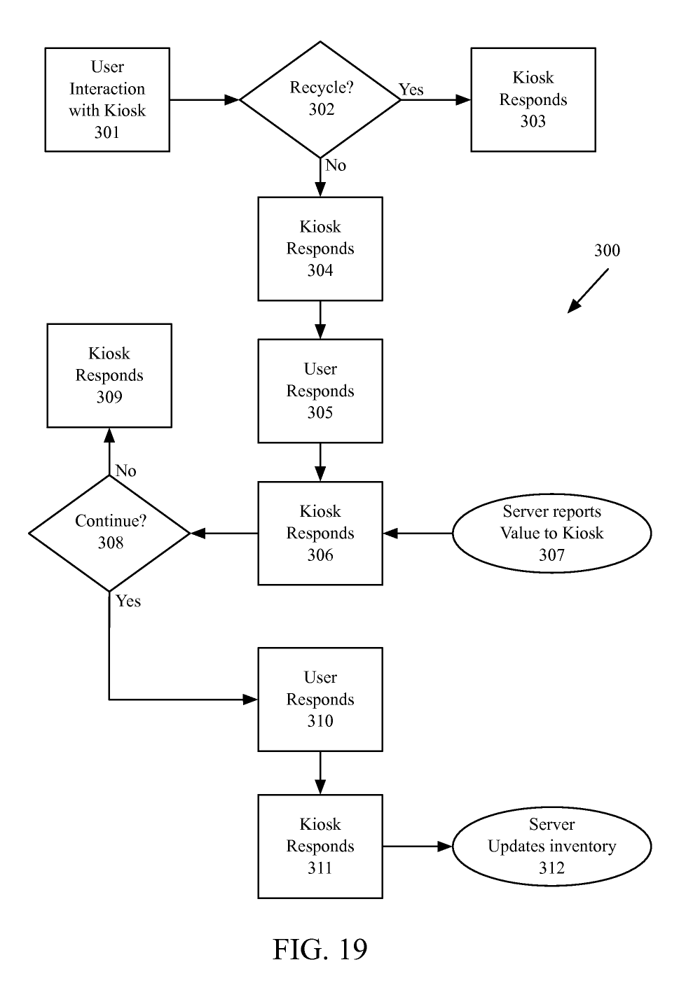

A flow chart for a preferred recycling method is shown in FIG. 19. At step 301 a customer elects to sell or recycle an electronic device. The customer checks to see if the electronic device is supported for sale/refurbishing from a list on the screen of the kiosk. The customer activates the on-screen menu system and either enters the phone model directly or goes through a series of menus to determine if the electronic device is eligible for sale or only for recycling. At decision block 302 it is determined if the electronic device is only available for recycling. If yes, (i.e. it is not on the list of electronic device available for reselling) the customer can insert the electronic device into receptacle at step 303 and the electronic device falls into bin 112 for recycling.

If the electronic device is supported for refurbishment/resale the customer is then encouraged to engage the testing/rating operation of the system. At step 304, the system has determined the correct connector to couple to the electronic device. Connectivity options and are not limited to cable, standard or proprietary connectors, hard docks, reading removable or external physical memory or other wireless methods like WiFi, Bluetooth, RFID, NFC, and the like. At step 305 the electronic device is connected and inserted into inspection area 106. If this has been done correctly, the customer is given some indication (e.g. a green light) and the system proceeds to step 306. At step 306 the electronic device is tested for operation using diagnostics and operating via, for example, the OMSI interface. The diagnostics preferably includes electrical and physical testing including testing the electronic device's battery, screen, memory, button functionality and structural integrity.

Preferably, the electronic device is imaged and analysis software is used to identify scratches, cracks, wear patterns, dents, broken or missing pieces, inclusion of features such as lenses, buttons, connectors, badges, labeling and/or branding. Identification may be done by image comparison or other similar methods where the image taken of the electronic device is normalized and compared to a reference image. Other inspection methods may be used in conjunction with visual and/or electrical testing including weighing to determine specific weight and use that data to further refine verification of manufacturer and verification of exact device model. In another embodiment, the photographic image is used to identify the correct manufacturer and model number/product number. Visual identification could include any combination of the following: calculations based upon measurement, physical (e.g., mm, inches), pixel count or other. Identification based upon electronic device dimensions, location/size of buttons, LCD and other physical characteristics. One camera or multiple cameras may be used to determine height, width, depth as needed. Identification based on OCR (Optical Character Recognition) of identifiers such as Carrier (for phone and tablet computers), brand, model, serial number, other identifiers. Identification based upon barcodes. Consumer may be asked to orient CE on its front, back, side and then asked to change orientation as needed. Consumer may even be asked to remove CE cover(s), batteries and the like in order to gain access to identifiable items, such alphanumeric or barcode data. The kiosk 100 provides a way to use visual inspection with electrical inspection to identify a device, determine its value, and reduce possible fraud.

In one embodiment, the kiosk 100 communicates with the carrier associated with a mobile phone to collect any information that could be germane to the device, including, for example, validation or authentication, registered ownership, account status, time in service, and the like. In some cases, when the customer's identification information does not match the registered owner information, the kiosk 100 automatically contacts the assumed owner in some manner (automated telephone call, email, text message, etc.) to alert the owner of the phone of the possible transaction.

Another feature of an embodiment of the kiosk 100 is to determine if there is personal information on the electronic device. This is determined by the presence of data in particular storage registers in the memory (e.g., quick-key stored numbers) or by looking at file types (jpegs, mp3's, etc.,), or just assuming all non-default storage locations must contain personal data. The customer is offered the chance to erase the data from the phone. One option allows the customer to request that the data be first downloaded and then sent to a location designated by the customer (e.g., email address, website, etc.). In another embodiment, there is a slot for the customer to enter a memory card (e.g. USB drive. memory stick, etc.) whereupon the kiosk 100 uploads the data to the memory device. In still another embodiment, the kiosk 100 offers a web location from which the user retrieves the data at some later time if desired. In another embodiment, the user elects to have the data placed in another electronic device purchased by the customer at the kiosk 100 or in the location of the kiosk 100 or some other store. The customer preferably selects a user name and password to access the system provided storage location.

Once the value is determined, the value is provided at step 307 to the kiosk. The kiosk 100 then offers the customer a price or other remuneration for the phone that is typically less than the resale value. In other embodiments, the kiosk 100 offers the customer a price or remuneration that is at the current real-time market price. At step 308 it is determined if the user wishes to accept the offer. If not, the kiosk 100 proceeds to step 309 and opens the door and releases the electronic device back to the customer. If the user wishes to accept the offer, the kiosk 100 proceeds to step 310. At a point where the user accepts a price, the kiosk 100 may then lock down the inspection area to prevent further access to the electronic device by the user. The kiosk 100 then disconnects any cables that have been attached. At step 310, the user indicates acceptance of the decision by confirming on the keypad or touch-screen. At this point the kiosk 100 proceeds with deleting the personal data from the electronic device. In addition, once the transaction is confirmed, the kiosk 100 tags the electronic device with a transaction number that is associated with the diagnostic data and the transaction itself. This is preferably a printed adhesive label that is affixed physically to the phone and/or the loading of electronic data corresponding to the transaction number onto the phone itself for traceability purposes.

At step 311, the kiosk 100 completes any additional testing and diagnostics of the electronic device, disconnects the cable from the electronic device, and prints a receipt for the customer. Transfer of funds may be authorized via the kiosk 100 by crediting a customer credit card or account by dispensing cash, or by dispensing a voucher or coupon. At step 312 the kiosk 100 updates its inventory database and transmits the update via a communications network to a kiosk server.

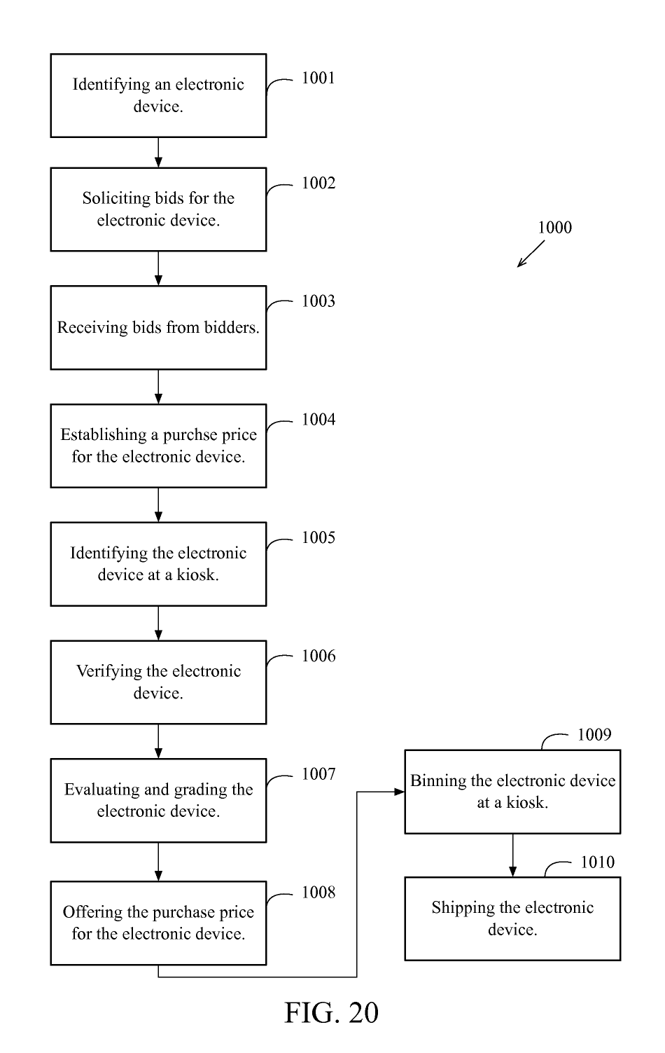

One preferred method for a pre-acquisition auction is illustrated in the flow chart of FIG. 20. A method for analysis of an electronic device and financial remuneration to a user for submission of the electronic device is generally designated 1000. At block 1001, an electronic device is identified. At block 1002, bids are solicited for a used model of the electronic device in a predetermined condition. The bids are preferably solicited online through a website and the bidders are preferably pre-qualified. At block 1003, bids for the used model of the electronic device are received from a plurality of bidders. At block 1004, a purchase price to pay for the used model of the electronic device is set based on the plurality of bids received from the plurality of bidders. Typically, the purchase price is based on the winning bid. The shipping information for the winning bidder is preferably obtained at this time. At block 1005, a used model of the electronic device is identified at a recycling kiosk for the electronic device. Preferably, a consumer desires to recycle the electronic device. At 1006, the integrity of the used model of the electronic device is verified at the recycling kiosk. Preferably, the condition of the electronic device is established at the kiosk, with the kiosk determining any damage to the electronic device based on visual and electronic analysis of the electronic device. At block 1007, the electronic device is evaluated and graded. At block 1008, the purchase price for the used model of the electronic device is offered to a consumer at the kiosk. At block 1009, the electronic device is automatically binned after purchasing the used model of the electronic device from the consumer at the kiosk. At block 1010, the electronic device is shipped to the winning bidder.

Preferably, the kiosk 100 of the method comprises a housing 105, the housing 105 comprising a user interface on an exterior surface of the housing for the user to input information, an upper dome and a lower dome, wherein the upper dome and the lower dome comprise a plurality of mirrors. The kiosk 100 further comprises an upper chamber camera, a lower chamber camera and a transparent surface. The kiosk 100 further comprises a processor 160 within the housing and in communication with the at least one camera, the processor 160 configured to identify the brand and model number of the mobile communication device based on at least one of the information from the user and the images from the at least one camera, the processor 160 configured to determine a purchase price for the used model of the mobile communication device.

An alternative method for a pre-acquisition auction begins with a mobile communication device identified for acquisition. Bids are solicited for a used model of the mobile communication device. Bids for the used model of the mobile communication device are received from a plurality of bidders. A purchase price to pay for the used model of the mobile communication device is set based on the plurality of bids received from the plurality of bidders. A used model of the mobile communication device is identified at a recycling kiosk for the mobile communication device. The integrity of the used model of the mobile communication device is verified at the recycling kiosk. The purchase price for the used model of the mobile communication device is offered to a consumer at the kiosk. The mobile communication device is automatically binned after purchasing the used model of the mobile communication device from the consumer at the kiosk. The mobile communication device is shipped to the winning bidder.

Another alternative method for a pre-acquisition auction begins with establishing a plurality of pre-acquisition purchase prices. Each of the plurality of pre-acquisition purchase prices is established for a recycled electronic device in a predetermined condition. Each of the pre-acquisition purchase prices is established by a winning bid from a bidder of a plurality of bidders for a recycled electronic device. An electronic device is positioned in an inspection area of a kiosk. The inspection area has at least one camera. The electronic device or a portion thereof is imaged. The image of the electronic device obtained by the at least one camera disposed in the inspection area is inspected to determine if the electronic device has any defects. The electronic device is identified and a condition of the electronic device is determined. A matching pre-acquisition purchase price is selected from the plurality of pre-acquisition purchase prices for the electronic device. A consumer is offered the pre-acquisition purchase price for the electronic device.

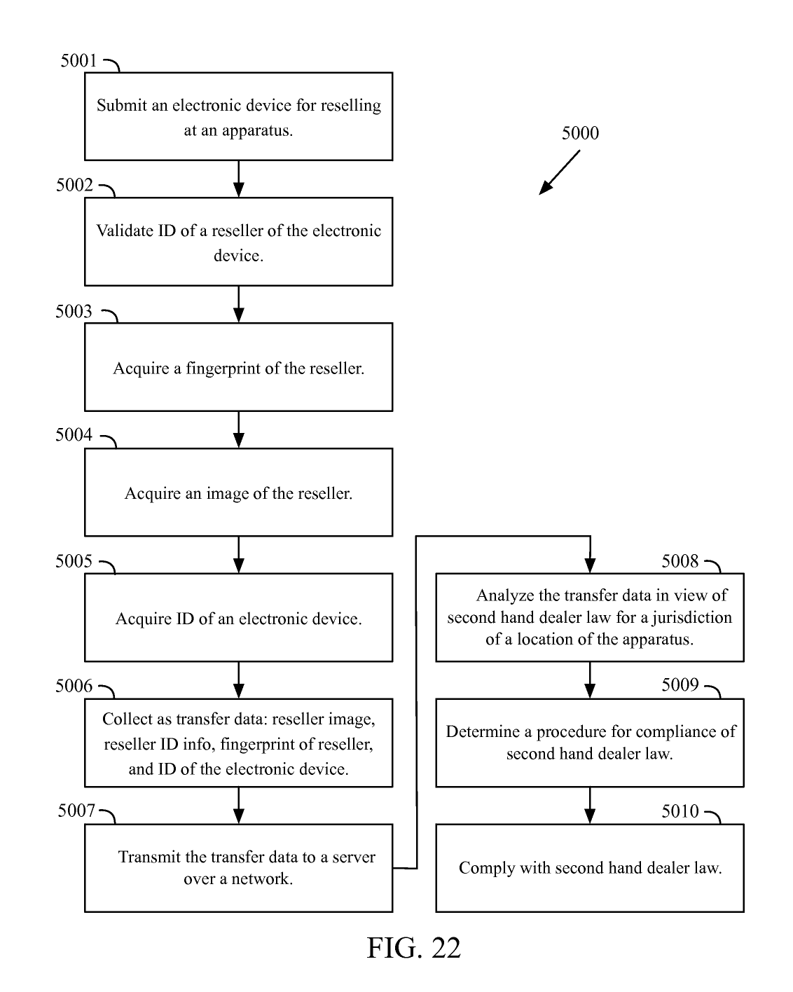

A flow chart of a method 5000 for reselling electronic devices in compliance with second hand dealer laws is shown in FIG. 22. At block 5001, an electronic device is submitted for reselling at an apparatus. At block 5002, an identification of a reseller of the electronic device is acquired at the card reader of the kiosk. At block 5003, a fingerprint of the reseller is acquired at the fingerprint reader of the kiosk, preferably a thumbprint. At block 5004, an image of the reseller is acquired by the external cameras of the kiosk. At block 5005, an identification of an electronic device is acquired at the kiosk. At block 5006, transfer data for the reseller is collected and includes the recycler image, the reseller identification, the fingerprint of the reseller, and the identification of the electronic device. At block 5007, the transfer data is transmitted to a server over a network. At block 5008, the transfer data is analyzed in view of a second hand dealer law for a jurisdiction of a location of the kiosk. At block 5009, a procedure is determined for compliance of the second hand dealer law based on the jurisdiction of the kiosk and the goods resold. At block 5010, the operation complies with the second hand dealer law.

The method and system for complying with second hand dealer laws can be utilized with Bowles, U.S. patent application Ser. No. 13/792,030, for a Mini-Kiosk For Recycling Electronic Devices, filed on Mar. 9, 2013, which is hereby incorporated by reference in its entirety. The method and system for complying with second hand dealer laws can be utilized with Bowles et al, U.S. patent application Ser. No. 13/753,539, for a Visual Analysis Of Recyclable Electronic Devices, filed on Jan. 30, 2013, which is hereby incorporated by reference in its entirety. The method and system for complying with second hand dealer laws can be utilized with Bowles et al, U.S. patent application Ser. No. 13/658,825, for a Method And Apparatus For Recycling Electronic Devices, filed on Oct. 24, 2012, which is hereby incorporated by reference in its entirety. The method and system for complying with second hand dealer laws can be utilized with Bowles et al, U.S. patent application Ser. No. 13/733,984, for a Method And Apparatus For Recycling Electronic Devices, filed on Jan. 14, 2013, which is hereby incorporated by reference in its entirety. The method and system for complying with second hand dealer laws can be utilized with Bowles et al, U.S. patent application Ser. No. 13/705,252, for a Pre-Acquisition Auction For Recycled Electronic Devices, filed on Dec. 5, 2012, which is hereby incorporated by reference in its entirety.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes modification and substitutions of equivalents may be made therein without departing from the spirit and scope of this invention which is intended to be unlimited by the foregoing except as may appear in the following appended claims. Therefore, the embodiments of the invention in which an exclusive property or privilege is claimed are defined in the following appended claims.

I claim as my invention the following:

1. A system for reselling electronic devices in compliance with second hand dealer laws, the system comprising:
an apparatus comprising a fingerprint reader, an identification reader, an exterior imaging component, a processor, an inspection area, an imaging component within the inspection area, and an electrical connector within the inspection area, the electrical connector capable of connection to an electronic device positioned within the inspection area;
a network;
a server with a database, the server connected to the apparatus over the network;
wherein the processor of the apparatus is configured to validate an identification of a recycler, process a fingerprint of the reseller to the database, photograph an image of the recycler to the database, and acquire an identification of the electronic device, the processor configured to collect as transfer data the image of the reseller, the identification information of the reseller, the fingerprint of the reseller, the identification of the electronic device, the processor configured to transmit the transfer data to the server over the network;
wherein the server is configured to analyze the transfer data in view of a second hand dealer law for a jurisdiction of a location of the apparatus, determine a procedure for compliance of the second hand dealer law, and comply with the second hand dealer law.

2. The system according to claim 1 further comprising a remote location with an attendant for interacting with the reseller.

3. The system according to claim 1 wherein the fingerprint is a thumbprint.

4. The system according to claim 1 wherein the identification of the electronic device is an IMEI, MEID, or serial number.

5. The system according to claim 1 further comprising transmitting a compliance report with the second hand dealer law to a regulatory agency of the jurisdiction.

6. The system according to claim 1 further comprising storing the transfer data at the database.

7. The system according to claim 1 wherein the apparatus further comprises:
a housing; a user interface on an exterior surface of the housing for the user to input information;
wherein the processor is in communication with the imaging component, the electrical connector and the user interface, the processor configured to identify the brand and model number of the electronic device based on at least one of the information from the user and the images from the imaging component, the processor configured to perform a visual analysis of the display of the electronic device, the processor configured to perform an electrical analysis of the electronic device, the processor configured to determine a financial remuneration value for the electronic device and the processor configured to manage the data transfer from the electronic device.

8. The system according to claim 1 wherein the electronic device is a mobile phone.

9. The system according to claim 1 wherein the server uses facial recognition software to identify a reseller based on an image acquired from the kiosk and an image of the reseller's identification, and sever is configured to compare the two images.

10. A method for reselling electronic devices in compliance with second hand dealer laws, the method comprising:
submitting an electronic device for reselling at an apparatus;
validating an identification of a reseller of the electronic device;
acquiring a fingerprint of the reseller;
acquiring an image of the reseller;
acquiring an identification of an electronic device;
collecting as transfer data the reseller image, the reseller identification information, the fingerprint of the reseller, and the identification of the electronic device;
transmitting the transfer data to a server over a network;
analyzing the transfer data in view of a second hand dealer law for a jurisdiction of a location of the apparatus;
determining a procedure for compliance of the second hand dealer law; and
complying with the second hand dealer law.

11. The method according to claim 10 wherein the apparatus comprises a fingerprint reader, an identification reader, an exterior imaging component, a processor, an inspection area, an imaging component within the inspection area, and an electrical connector within the inspection area, the electrical connector capable of connection to an electronic device positioned within the inspection area.

12. The method according to claim 10 further comprising interacting with an attendant located at a remote location.

13. The method according to claim 10 wherein the fingerprint is a thumbprint.

14. The method according to claim 10 wherein the identification of the electronic device is an IMEI, MEID, or serial number.

15. The method according to claim 10 further comprising transmitting a compliance report with the second hand dealer law to a state agency.

16. The method according to claim 10 further comprising storing the transfer data at the database.

17. The method according to claim 11 wherein the apparatus further comprises:
a housing; a user interface on an exterior surface of the housing for the user to input information;
wherein the processor is in communication with the imaging component, the electrical connector and the user interface, the processor configured to identify the brand and model number of the electronic device based on at least one of the information from the user and the images from the imaging component, the processor configured to perform a visual analysis of the display of the electronic device, the processor configured to perform an electrical analysis of the electronic device, the processor configured to determine a financial remuneration value for the electronic device and the processor configured to manage the data transfer from the electronic device.

18. The method according to claim 10 wherein the electronic device is a mobile phone.

19. The method according to claim 10 further comprising using facial recognition software to identify a reseller based on an image acquired from the kiosk and an image of the reseller's identification, and comparing the two images.

20. The method according to claim 14 wherein the identification of the electronic device is compared against a stolen electronic device database as a filter prior to purchasing the electronic device from the reseller.
